(19) United States
(12) Patent Application Publication
(10) Pub. No.: US 2018/0058578 A1
(43) Pub. Date: Mar. 1, 2018

(54) UNIVERSAL OPERATING DEVICE FOR OVERDRIVE GEARBOX AND USE METHOD THEREOF

(71) Applicant: Dongfeng Commercial Vehicle Company Limited, Wuhan City (CN)

(72) Inventors: WEI ZHAN, Wuhan City, Hubei Province (CN); JIE LI, Wuhan City, Hubei Province (CN); JIANHUA LI, Wuhan City, Hubei Province (CN); YONGSHENG JU, Wuhan City, Hubei Province (CN); XIAOYAN GUO, Wuhan City, Hubei Province (CN); WANYONG ZHOU, Wuhan City, Hubei Province (CN); ZHIHONG WU, Wuhan City, Hubei Province (CN); SHUBIN WANG, Wuhan City, Hubei Province (CN); PAN XIANG, Wuhan City, Hubei Province (CN)

(21) Appl. No.: 15/687,443

(22) Filed: Aug. 26, 2017

(30) Foreign Application Priority Data
Aug. 26, 2016 (CN) 201610741006.3

(51) Int. Cl. F16H 63/30; F16H 61/36

(52) U.S. Cl. CPC F16H 63/30; F16H 61/36

(57) ABSTRACT

A universal operating device for an overdrive gearbox and a use method thereof, including a gearbox gear selecting and shifting shaft, and a gear selecting and shifting rocker arm and a gear selecting and shifting block which are arranged on the gearbox gear selecting and shifting shaft, where one end of the gearbox gear selecting and shifting shaft is separately in transmission fit with a gear selecting flexible shaft and a gear shifting flexible shaft through the gear selecting and shifting rocker arm, and the other end of the gearbox gear selecting and shifting shaft is in transmission fit with a gear shifting guide block through the gear selecting and shifting block; the gear selecting flexible shaft is in transmission fit with the gear selecting and shifting rocker arm through an overdrive gear switching device; and the overdrive gear switching device includes a gear shifting fork, the upper end of the gear shifting fork is in transmission fit with the upper end of the gear selecting and shifting rocker arm, and the lower end of the gear shifting fork is in transmission fit with the lower end of the gear selecting and shifting rocker arm. In use, the transmission direction of the gear selecting and shifting shaft is changed by utilizing the translation of the rocker arm without changing an inner structure of the gearbox. Therefore, the design is simple in structure and low in manufacture cost, and can realize gear order reverse shifting of the gearbox without changing the inner structure of the gearbox.

### TECHNICAL FIELD

The present invention relates to a gearbox operating device, and in particular, to a universal operating device for an overdrive gearbox and a use method thereof, which are specifically applicable for simplifying a gearbox structure and reduce designing and manufacturing cost.

### BACKGROUND ART

With flourishing development of automobile markets, a basic gearbox needs to be provided with more than two speed ratios, such as a direct gear and an overdrive gear, to satisfy requirements for market segmentation. As the market demands for lifting automobile gear shifting comfort, gear shifting assistance systems are increasingly used in gearbox gear shifting systems, especially in the commercial vehicle market. As the gear arrangement of the overdrive gear gearbox is different from that of the direct gear, resulting in that an original operating mechanism used by the direct gear gearbox cannot be directly adapted to the overdrive gear gearbox of the same platform. To resolve this problem, the providers have to redesign a new operating system or add a gear shifting conversion mechanism to the original operating system. For the two methods, at least a new gear shifting fork needs to redesigned to meet the requirements.

The utility model patent with a Chinese patent authorized publication No. CN204213322U and an authorized publication date Mar. 18, 2015 discloses a top cover operating mechanism assembly with an overdrive gear conversion function. A gear shifting conversion rocker arm subassembly is disposed inside the top cover assembly, and the gear shifting conversion rocker arm subassembly includes a gear shifting conversion rocker arm, an isolation sleeve, a branch bolt, and a guide plate; the middle part of the gear shifting conversion rocker arm is sleeved on a locking nut, one end is clamped on a gear shifting block, and the other end is clamped on the gear shifting guide block. The gear shifting conversion rocker arm is installed inside the top cover assembly. When the gear shifting block dials the gear shifting conversion rocker arm towards a direction, the other end of the gear shifting conversion rocker arm drives the gear shifting guide block towards a reverse direction, so as to implement gear shifting conversion of the overdrive gear and the direct gear on the top cover operating mechanism by using the lever principle. Although the utility model can implement direction conversion of the overdrive gear, it has the following defects:

The utility model needs to add a direction conversion device inside the gearbox to meet the gear shifting requirement of the overdrive gear, thereby occupying relatively large arrangement space, increasing installation difficulty, and increasing production cost.

### SUMMARY OF THE INVENTION

An objective of the present invention is to overcome a problem that a direction conversion device needs to be added inside the gearbox in the prior art, and to provide a universal operating device for an overdrive gearbox without adding a direction conversion device in the gearbox, and a use method thereof.

To realize the foregoing objectives, the technical solutions of the present invention are that:

A universal operating device for an overdrive gearbox includes a gearbox gear selecting and shifting shaft, and a gear selecting and shifting rocker arm and a gear selecting and shifting block which are arranged on the gearbox gear selecting and shifting shaft, where one end of the gearbox gear selecting and shifting shaft is separately in transmission fit with a gear selecting flexible shaft and a gear shifting flexible shaft through the gear selecting and shifting rocker arm, and the other end of the gearbox gear selecting and shifting shaft is in transmission fit with a gear shifting guide block through the gear selecting and shifting block;

the gear selecting flexible shaft is in transmission fit with the gear selecting and shifting rocker arm through an overdrive gear switching device; and the overdrive gear switching device includes a gear shifting fork, the upper end of the gear shifting fork is in transmission fit with the upper end of the gear selecting and shifting rocker arm, and the lower end of the gear shifting fork is in transmission fit with the lower end of the gear selecting and shifting rocker arm.

The gearbox gear selecting and shifting shaft has a circular tube structure, and the gear selecting and shifting rocker arm and the gear selecting and shifting block are welded on an outer wall of the gearbox gear selecting and shifting shaft; an interlocking base is sleeved on the gearbox gear selecting and shifting shaft, and the gear selecting and shifting block is in transmission fit with the gear shifting guide block after passing through the interlocking base.

a self-locking base is fixedly connected to the gearbox gear selecting and shifting shaft, the cross section of the self-locking base is W-shaped, the self-locking base is in limiting fit with a locking valve, and the self-locking base is welded on the outer wall of the gearbox gear selecting and shifting shaft.

the gear shifting fork includes a U-shaped fork lever, an ordinary gear selecting lever, a direct gear and overdrive gear selecting lever, and a transmission push lever; the ordinary gear selecting lever and the direct gear and overdrive gear selecting lever are disposed parallel to the gearbox gear selecting and shifting shaft; one end of the ordinary gear selecting lever is in insertion fit with a first gear shifting hole on the upper end of the gear selecting and shifting rocker arm; the other end of the ordinary gear selecting lever is fixedly connected to the upper end of the U-shaped fork lever; one end of the direct gear and overdrive gear selecting lever is in insertion fit with a second gear shifting hole on the lower end of the gear selecting and shifting rocker arm; the other end of the direct gear and overdrive gear selecting lever is fixedly connected to the lower end of the U-shaped fork lever; and a transmission push lever is fixedly connected to the middle part of the U-shaped fork lever, and the transmission push lever is in transmission fit with the gear shifting flexible shaft.

the overdrive gear switching device further includes the gear shifting booster, a power output end of the gear shifting booster is fixedly connected to one end of the transmission push lever, the other end of the transmission push lever is fixedly connected to the middle part of the U-shaped fork lever, the middle part of the transmission push lever is in transmission fit with the gear shifting flexible shaft, and the gear shifting booster is a pneumatic device.

the gear shifting fork further includes a U-shaped transmission groove element, the bottom of the U-shaped transmission groove element is fixedly connected to the middle part of the transmission push lever, the U-shaped transmission groove element is disposed parallel to the gearbox gear selecting and shifting shaft, and the gear shifting flexible shaft are in transmission fit with the U-shaped fork lever by sequentially passing through an L-shaped gear shifting transmission plate, the U-shaped transmission groove element, and the transmission push lever;

one end of the L-shaped gear shifting transmission plate is connected to the gear shifting flexible shaft, the other end of the L-shaped gear shifting transmission plate is in transmission fit with the U-shaped transmission groove element through a gear shifting block on the bottom of the L-shaped gear shifting transmission plate, the middle part of the L-shaped gear shifting transmission plate is provided with a gear shifting positioning pin hole, the gear shifting positioning pin hole is provided with a gear shifting positioning pin that is in rotation fit with the gear shifting positioning pin hole, and the bottom of the gear shifting positioning pin is fixedly connected to a gearbox casing.

a minimum distance between the end surface of the ordinary gear selecting lever and the end surface of the direct gear and overdrive gear selecting lever along an axial direction of the gearbox gear selecting and shifting shaft is 1 mm to 3 mm, and the end surface of the ordinary gear selecting lever and the end surface of the direct gear and overdrive gear selecting lever are of arc surface structures.

the interlocking base includes a base and an interlocking block, the cross section of the base is of a reverse U-shaped structure, the middle part of the base is provided with a block installation hole, the gear selecting and shifting block is in fit with the block installation hole, interlocking block is respectively disposed on the top of the base and two sides of the block installation hole, and the interlocking block and the top of the gear selecting and shifting block are disposed in a gearbox gear selecting groove; and the width of an opening on the bottom of the base is less than an outer diameter of the gearbox gear selecting and shifting shaft.

a gear selecting U-shaped groove is disposed on the top of the gear selecting and shifting rocker arm, the gear selecting U-shaped groove is disposed perpendicular to the gearbox gear selecting and shifting shaft, and the gear selecting flexible shaft is in transmission fit with the gearbox gear selecting and shifting shaft by sequentially using an L-shaped gear selecting transmission plate, the gear selecting U-shaped groove, and the gear selecting and shifting rocker arm;

one end of the L-shaped gear selecting transmission plate is connected to the gear shifting flexible shaft, the other end of the L-shaped gear selecting transmission plate is in transmission fit with the gear selecting U-shaped groove through a gear selecting block on the bottom of the L-shaped gear selecting transmission plate, the middle part of the gear selecting transmission plate is provided with a gear selecting positioning pin hole, the gear selecting positioning pin hole is provided with a gear selecting positioning pin that is in rotation fit with the gear selecting positioning pin hole, and the bottom of the gear selecting positioning pin is fixedly connected to the gearbox casing.

A use method of a universal operating device for an overdrive gearbox, the use method including the following steps:

Step 1: gear selecting and shifting of an ordinary gear: when performing a gear selecting and shifting operation of the ordinary gear, the gear selecting flexible shaft pushes the gear selecting and shifting rocker arm to move so as to enable the ordinary gear selecting lever to be inserted into the first gear shifting hole; the direct gear and overdrive gear selecting lever is located outside the second gear shifting hole; when the gear selecting and shifting block is located between two gear shifting guide blocks, the interlocking base is prohibited from shifting the gear; when the gear selecting and shifting block is located in a single gear shifting guide block, the gear shifting operation has four situations:
when upshifting to a next gear, the rotation direction of the gearbox gear selecting and shifting shaft is set as the forward rotation direction of the gearbox gear selecting and shifting shaft;
a. moving forward by an odd gear in the ordinary gear: the ordinary gear selecting lever pushes, under the acting force of the gear shifting flexible shaft, the gearbox gear selecting and shifting shaft to rotate forward so as to enter into the odd gear of the ordinary gear, and upshift is completed;
b. moving backward by an odd gear in the ordinary gear: the ordinary gear selecting lever pushes, under the acting force of the gear shifting flexible shaft, the gearbox gear selecting and shifting shaft to rotate reversely so as to exit from the odd gear of the ordinary gear, and downshift is completed;
c. moving forward by an even gear in the ordinary gear: the ordinary gear selecting lever, pushes, under the acting force of the gear shifting flexible shaft, the gearbox gear selecting and shifting shaft to rotate reversely to enter into the even gear of the ordinary gear, and upshift is completed;
d. moving backward by an even gear of the ordinary gear: the ordinary gear selecting lever, pushes, under the acting force of the gear shifting flexible shaft, the gearbox gear selecting and shifting shaft to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever pushes, under the acting force of the gear shifting flexible shaft, the gearbox gear selecting and shifting shaft to rotate forward to exit from the top gear of the ordinary gear; Gear selecting: the gear selecting flexible shaft pushes the gear selecting and shifting rocker arm to move to enable the direct gear and overdrive gear selecting lever to be inserted into the second gear shifting hole; at this time, the ordinary gear selecting lever exit to outside the first gear shifting hole; during a gear selecting process, when the gear selecting and shifting block is located between two gear shifting guide blocks, the interlocking base is prohibited from shifting the gear; when the gear selecting and shifting block is located in a single gear shifting guide block, gear shifting can be performed; entering the direct gear: the direct gear and overdrive gear selecting lever pushes, under an acting force of the gear shifting flexible shaft, the gearbox gear selecting and shifting shaft to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm to move so as to enable the direct gear and overdrive gear selecting lever to be inserted into the second gear shifting hole, and the ordinary gear selecting lever is located outside the first gear shifting hole; moving from the direct gear to the overdrive gear: the direct gear and overdrive gear selecting lever pushes, under the acting force of the gear shifting flexible shaft, the gearbox gear selecting and shifting shaft to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm to move so as to enable the direct gear and overdrive gear selecting lever to be inserted into the second gear shifting hole, and the ordinary gear selecting lever is located outside the first gear shifting hole; moving from the overdrive gear to the direct gear: the direct gear and overdrive gear selecting lever pushes, under the acting force of the gear shifting flexible shaft, the gearbox gear selecting and shifting shaft to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever pushes, under the acting force of the gear shifting flexible shaft, the gearbox gear selecting and shifting shaft to rotate forward to exit from the direct gear; Gear selecting: the gear selecting flexible shaft pushes the gear selecting and shifting rocker arm to move to enable the ordinary gear selecting lever to be inserted into the first gear shifting hole; at this time, the direct gear and overdrive gear selecting lever exit to outside the second gear shifting hole; when the gear selecting and shifting block is located between two gear shifting guide blocks, the interlocking base is prohibited from shifting the gear; when the gear selecting and shifting block is locate in a single gear shifting guide block, entering into the top gear of the ordinary gear: the ordinary gear selecting lever pushes under the acting force of the gear shifting flexible shaft, the gearbox gear selecting and shifting shaft to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.

As compared with the prior art, the beneficial effects of the present invention are that:

1. in a universal operating device for an overdrive gearbox of the present invention, the upper end and the lower end of the structure of the gear selecting and shifting rocker arm can perform transmission gear shifting; different gear shifting levers are selected by means of gear shifting movement of the gear selecting and shifting rocker arm; when the gear selecting and shifting rocker arm is in transmission fit with the ordinary gear selecting lever, the operating device can complete gear selecting and shifting of the ordinary gear; when the gear selecting and shifting rocker arm is in transmission fit with the direct gear and overdrive gear selecting lever, the gear shifting force is in a reverse direction, and the operating device can implement gear shifting of the direct gear and the overdrive gear; the design can implement gearbox order reverse shifting without adding a gear shifting conversion mechanism in the gearbox, greatly reducing design cost and manufacturing cost of the gearbox, and improving adaptability of the gearbox; meanwhile, designs of the gear shifting fork and the gear selecting and shifting rocker arm have simple structures, easy to be manufactured and assembled, have high applicable value, and can effectively reduce manufacturing cost. Therefore, the design is simple in structure and has high applicability, and can realize gear order reverse shifting of the gearbox without changing the inner structure of the gearbox.

2. the structure of the interlocking base in the universal operating device for an overdrive gearbox of the present invention can not only avoid error gear shifting of the gear selecting and shifting block, but also regulate a moving track of the gear selecting and shifting rocker arm in a gear shifting process, further improving gear selecting reliability of the gear shifting fork and the gear selecting and shifting rocker arm. Therefore, this design can effectively implementing interlocking, and has high gear selecting reliability.

3. the gearbox gear selecting and shifting shaft in the universal operating device for an overdrive gearbox of the present invention has a hollow structure, and this design effectively reduces the weight of the gear selecting and shifting shaft when ensuring necessary mechanical strength of the gear selecting and shifting shaft, and implements a ultralight device; the gear selecting and shifting block, the gear selecting and shifting rocker arm, and the self-locking base are welded on the gear selecting and shifting shaft, reducing the weight of the gearbox gear selecting and shifting shaft, simplifying a manufacturing process and an assembling process, effectively reducing manufacturing cost, and shortening installation time. Therefore, the gearbox gear selecting and shifting shaft of this design has a simple structure, easy to be assembled and installed, and has a small mass, facilitating a ultralight device.

4. in the universal operating device for an overdrive gearbox of the present invention, the gear shifting fork is in transmission fit with the gear shifting booster, and the structure of the gear shifting booster can provide assistance for the gear shifting operation, and improve gear shifting comfort of the driver. Therefore, by using this design, the gear shifting operation is smooth and the gear shifting has good comfort.

5. in the universal operating device for an overdrive gearbox of the present invention, a minimum distance between the end surface of the ordinary gear selecting lever and the end surface of the direct gear and overdrive gear selecting lever along an axial direction of the gearbox gear selecting and shifting shaft is 1 mm to 3 mm; such design effectively ensures correctness of gear shifting of the gear selecting and shifting rocker arm, improving reliability of a gear shifting mechanism; meanwhile, the end surface of the ordinary gear selecting lever and the end surface of the direct gear and overdrive gear selecting lever are of arc surface structures; such design can further ensure non-interference of the gear shifting operation of the gear selecting and shifting rocker arm, and further improve reliability of a gear selecting mechanism. Therefore, by using this design, gear selecting is correct, and the gear selecting mechanism has high reliability.

6. in the universal operating device for an overdrive gearbox of the present invention, the L-shaped gear shifting transmission plate and the L-shaped gear selecting transmission plate are directly fixed on a gearbox casing respectively through the gear shifting positioning pin and the gear selecting positioning pin without additionally setting a support or setting a boss on the gear casing for fixing; meanwhile, the L-shaped gear shifting transmission plate and the L-shaped gear selecting transmission plate are designed to be simple L shapes, have simple structures and low processing requirements, greatly reducing manufacturing cost. Therefore, the transmission structure of this design is simple and convenient to be installed, a base does not need to be set and installed, and the production cost is low.

7. when in use, the universal operating device for an overdrive gearbox of the present invention selects different gear selecting levers by means of movement of the gear selecting and shifting rocker arm, and drives, by means of the movement of the gear selecting lever, the gearbox gear selecting and shifting shaft to rotate; when the gear shifting fork makes a same action, different gear selecting lever is in fit with the gear selecting and shifting rocker arm, and the rotation direction of the gear selecting and shifting shaft of the gearbox is reverse. Therefore, the design is simple in structure and convenient in use, and can realize gear order reverse shifting of the gearbox without changing the inner structure of the gearbox.

### BRIEF DESCRIPTION OF THE DRAWINGS

FIG. 1 is a schematic structural diagram of the present invention;

FIG. 2 is a three-dimensional schematic structural diagram of the present invention;

FIG. 3 is a schematic structural diagram of a gear shifting fork in FIG. 1;

FIG. 4 is a schematic structural diagram of an interlocking base in FIG. 1;

FIG. 5 is a schematic assembling diagram of an interlocking base in FIG. 1;

FIG. 6 is a schematic structural diagram of a self-locking base in FIG. 1;

FIG. 7 is a schematic structural diagram of an L-shaped gear shifting transmission plate in FIG. 1; and

FIG. 8 is a schematic structural diagram of an L-shaped gear selecting transmission plate in FIG. 1.

In the drawings: a gearbox gear selecting and shifting shaft 1, an overdrive gear conversion device, an overdrive gear switching device 11, a gear selecting and shifting rocker arm 2, a first gear shifting hole 21, a second gear shifting hole 22, a gear selecting U-shaped groove 23, a gear shifting fork 3, U-shaped fork lever 31, an ordinary gear selecting lever 32, a direct gear and overdrive gear selecting lever 33, a transmission push lever 34, a U-shaped transmission groove 35, a gear selecting and shifting block 4, an interlocking base 5, a block installation hole 51, a base 52, an interlocking block 53, a gear shifting booster 6, a self-locking base 7, a locking valve 71, an L-shaped gear shifting transmission plate 8, a gear shifting block 81, a gear shifting positioning pin hole 82, a gear shifting positioning pin 83, an L-shaped gear selecting transmission plate 9, a gear selecting block 91, a gear selecting positioning pin hole 92, and a gear selecting positioning pin 93.

### DETAILED DESCRIPTION OF THE INVENTION

The present invention is further described in detail with reference to the following accompany drawings and specific embodiments.

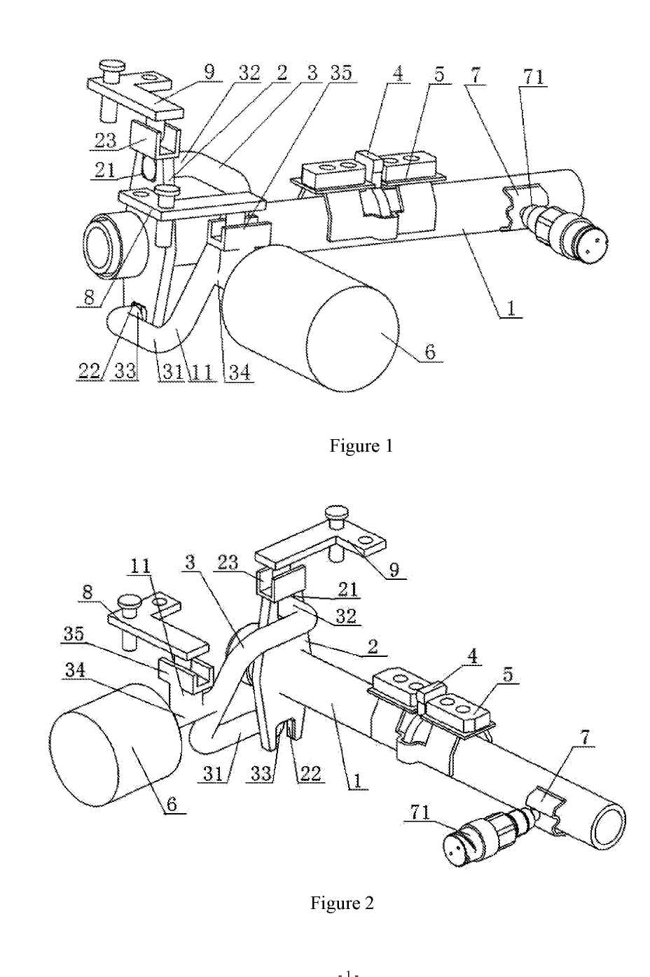

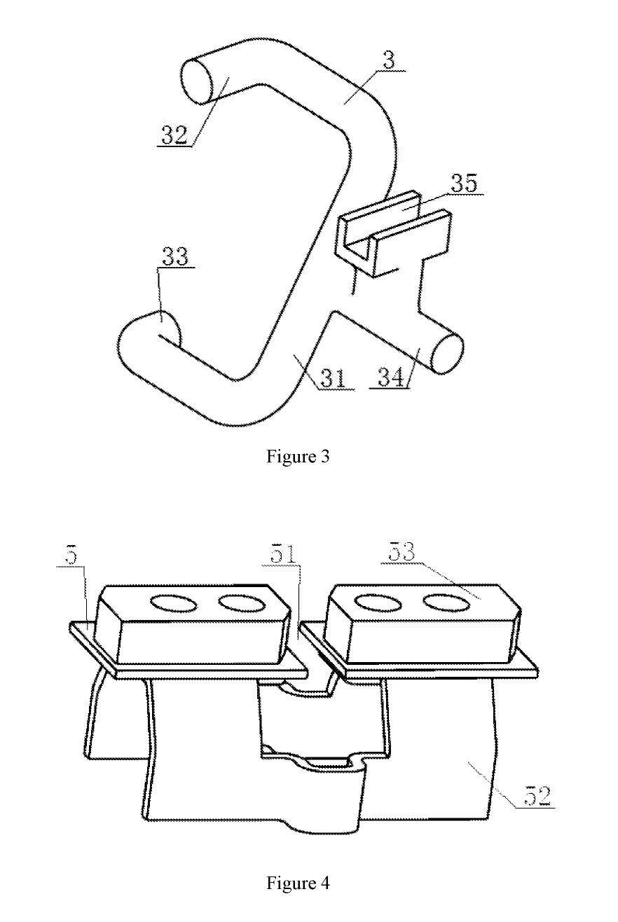

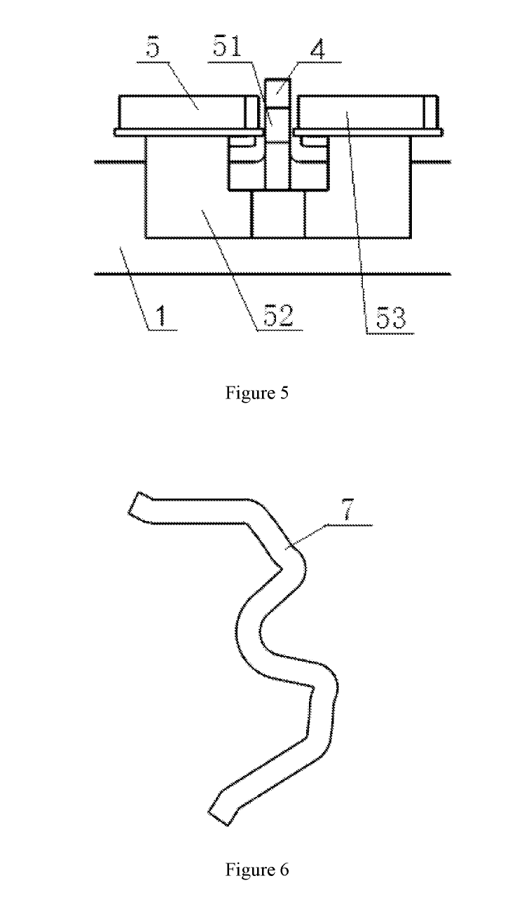

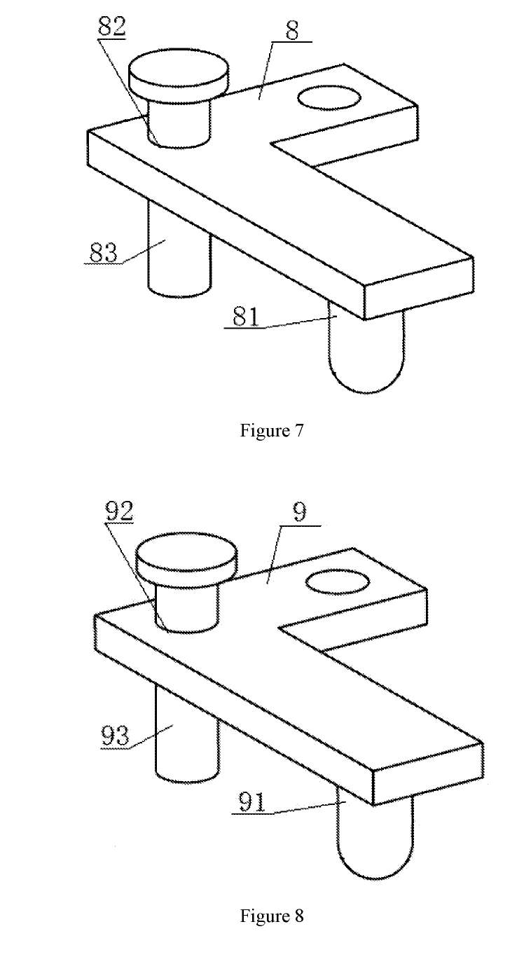

Referring to FIG. 1 to FIG. 8, a universal operating device for an overdrive gearbox includes a gearbox gear selecting and shifting shaft 1, and a gear selecting and shifting rocker arm 2 and a gear selecting and shifting block 4 which are arranged on the gearbox gear selecting and shifting shaft, where one end of the gearbox gear selecting and shifting shaft 1 is separately in transmission fit with a gear selecting flexible shaft and a gear shifting flexible shaft through the gear selecting and shifting rocker arm 2, and the other end of the gearbox gear selecting and shifting shaft 1 is in transmission fit with a gear shifting guide block through the gear selecting and shifting block 4;

the gear selecting flexible shaft is in transmission fit with the gear selecting and shifting rocker arm 2 through an overdrive gear switching device 11; and the overdrive gear switching device 11 includes a gear shifting fork 3, the upper end of the gear shifting fork 3 is in transmission fit with the upper end of the gear selecting and shifting rocker arm 2, and the lower end of the gear shifting fork 3 is in transmission fit with the lower end of the gear selecting and shifting rocker arm 2.

The gearbox gear selecting and shifting shaft 1 has a circular tube structure, and the gear selecting and shifting rocker arm 2 and the gear selecting and shifting block 4 are welded on an outer wall of the gearbox gear selecting and shifting shaft 1; an interlocking base 5 is sleeved on the gearbox gear selecting and shifting shaft 1, and the gear selecting and shifting block 4 is in transmission fit with the gear shifting guide block after passing through the interlocking base 5.

a self-locking base 7 is fixedly connected to the gearbox gear selecting and shifting shaft 1, the cross section of the self-locking base 7 is W-shaped, the self-locking base 7 is in limiting fit with a locking valve 71, and the self-locking base 7 is welded on the outer wall of the gearbox gear selecting and shifting shaft 1.

the gear shifting fork 3 includes a U-shaped fork lever 31, an ordinary gear selecting lever 32, a direct gear and overdrive gear selecting lever 33, and a transmission push lever 34; the ordinary gear selecting lever 32 and the direct gear and overdrive gear selecting lever 33 are disposed parallel to the gearbox gear selecting and shifting shaft 1; one end of the ordinary gear selecting lever 32 is in insertion fit with a first gear shifting hole 21 on the upper end of the gear selecting and shifting rocker arm 2; the other end of the ordinary gear selecting lever 32 is fixedly connected to the upper end of the U-shaped fork lever 31; one end of the direct gear and overdrive gear selecting lever 33 is in insertion fit with a second gear shifting hole 22 on the lower end of the gear selecting and shifting rocker arm 2; the other end of the direct gear and overdrive gear selecting lever 33 is fixedly connected to the lower end of the U-shaped fork lever 31; and a transmission push lever 34 is fixedly connected to the middle part of the U-shaped fork lever 31, and the transmission push lever 34 is in transmission fit with the gear shifting flexible shaft.

the overdrive gear switching device 11 further comprises the gear shifting booster 6, a power output end of the gear shifting booster 6 is fixedly connected to one end of the transmission push lever 34, the other end of the transmission push lever 34 is fixedly connected to the middle part of the U-shaped fork lever 31, the middle part of the transmission push lever 34 is in transmission fit with the gear shifting flexible shaft, and the gear shifting booster 6 is a pneumatic device.

the gear shifting fork 3 further includes a U-shaped transmission groove element 35, the bottom of the U-shaped transmission groove element 35 is fixedly connected to the middle part of the transmission push lever 34, the U-shaped transmission groove element 35 is disposed parallel to the gearbox gear selecting and shifting shaft 1, and the gear shifting flexible shaft are in transmission fit with the U-shaped fork lever 31 by sequentially passing through an L-shaped gear shifting transmission plate 8, the U-shaped transmission groove element 35, and the transmission push lever 34;

one end of the L-shaped gear shifting transmission plate 8 is connected to the gear shifting flexible shaft, the other end of the L-shaped gear shifting transmission plate 8 is in transmission fit with the U-shaped transmission groove element 35 through a gear shifting block 81 on the bottom of the L-shaped gear shifting transmission plate 8, the middle part of the L-shaped gear shifting transmission plate 8 is provided with a gear shifting positioning pin hole 82, the gear shifting positioning pin hole 82 is provided with a gear shifting positioning pin 83 that is in rotation fit with the gear shifting positioning pin hole 82, and the bottom of the gear shifting positioning pin 83 is fixedly connected to a gearbox casing.

a minimum distance between the end surface of the ordinary gear selecting lever 32 and the end surface of the direct gear and overdrive gear selecting lever 33 along an axial direction of the gearbox gear selecting and shifting shaft 1 is 1 mm to 3 mm, and the end surface of the ordinary gear selecting lever 32 and the end surface of the direct gear and overdrive gear selecting lever 33 are of arc surface structures.

the interlocking base 5 includes a base 52 and an interlocking block 53, the cross section of the base 52 is of a reverse U-shaped structure, the middle part of the base 52 is provided with a block installation hole 51, the gear selecting and shifting block 4 is in fit with the block installation hole 51, interlocking block 53 is respectively disposed on the top of the base 52 and two sides of the block installation hole 51, and the interlocking block 53 and the top of the gear selecting and shifting block 4 are disposed in a gearbox gear selecting groove; and the width of an opening on the bottom of the base 52 is less than an outer diameter of the gearbox gear selecting and shifting shaft 1.

a gear selecting U-shaped groove 23 is disposed on the top of the gear selecting and shifting rocker arm 2, the gear selecting U-shaped groove 23 is disposed perpendicular to the gearbox gear selecting and shifting shaft 1, and the gear selecting flexible shaft is in transmission fit with the gearbox gear selecting and shifting shaft 1 by sequentially using an L-shaped gear selecting transmission plate 9, the gear selecting U-shaped groove 23, and the gear selecting and shifting rocker arm 2;

one end of the L-shaped gear selecting transmission plate 9 is connected to the gear shifting flexible shaft, the other end of the L-shaped gear selecting transmission plate 9 is in transmission fit with the gear selecting U-shaped groove 23 through a gear selecting block 91 on the bottom of the L-shaped gear selecting transmission plate 9, the middle part of the gear selecting transmission plate 9 is provided with a gear selecting positioning pin hole 92, the gear selecting positioning pin hole 92 is provided with a gear selecting positioning pin 93 that is in rotation fit with the gear selecting positioning pin hole 92, and the bottom of the gear selecting positioning pin 93 is fixedly connected to the gearbox casing.

A use method of a universal operating device for an overdrive gearbox, the method including the following steps:

Step 1: gear selecting and shifting of an ordinary gear: when performing a gear selecting and shifting operation of the ordinary gear, the gear selecting flexible shaft pushes the gear selecting and shifting rocker arm 2 to move so as to enable the ordinary gear selecting lever 32 to be inserted into the first gear shifting hole 21; the direct gear and overdrive gear selecting lever 33 is located outside the second gear shifting hole 22; when the gear selecting and shifting block 4 is located between two gear shifting guide blocks, the interlocking base 5 is prohibited from shifting the gear; when the gear selecting and shifting block 4 is located in a single gear shifting guide block, the gear shifting operation has four situations:
when moving to a next gear, the rotation direction of the gearbox gear selecting and shifting shaft 1 is set as the forward rotation direction of the gearbox gear selecting and shifting shaft 1;
a. moving forward by an odd gear in the ordinary gear: the ordinary gear selecting lever 32 pushes, under the acting force of the gear shifting flexible shaft, the gearbox gear selecting and shifting shaft 1 to rotate forward so as to enter into the odd gear of the ordinary gear, and upshift is completed;
b. moving backward by an odd gear in the ordinary gear: the ordinary gear selecting lever 32 pushes, under the acting force of the gear shifting flexible shaft, the gearbox gear selecting and shifting shaft 1 to rotate reversely so as to exit from the odd gear of the ordinary gear, and downshift is completed;
c. moving forward by an even gear in the ordinary gear: the ordinary gear selecting lever 32, pushes, under the acting force of the gear shifting flexible shaft, the gearbox gear selecting and shifting shaft 1 to rotate reversely to enter into the even gear of the ordinary gear, and upshift is completed;
d. moving backward by an even gear of the ordinary gear: the ordinary gear selecting lever 32, pushes, under the acting force of the gear shifting flexible shaft, the gearbox gear selecting and shifting shaft 1 to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever 32 pushes, under the acting force of the gear shifting flexible shaft, the gearbox gear selecting and shifting shaft 1 to rotate forward to exit from the top gear of the ordinary gear; Gear selecting: the gear selecting flexible shaft pushes the gear selecting and shifting rocker arm 2 to move to enable the direct gear and overdrive gear selecting lever 33 to be inserted into the second gear shifting hole 22; at this time, the ordinary gear selecting lever 32 exit to outside the first gear shifting hole 21; during a gear selecting process, when the gear selecting and shifting block 4 is located between two gear shifting guide blocks, the interlocking base 5 is prohibited from shifting the gear; when the gear selecting and shifting block 4 is located in a single gear shifting guide block, gear shifting can be performed; entering the direct gear: the direct gear and overdrive gear selecting lever 33 pushes, under an acting force of the gear shifting flexible shaft, the gearbox gear selecting and shifting shaft 1 to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm 2 to move so as to enable the direct gear and overdrive gear selecting lever 33 to be inserted into the second gear shifting hole 22, and the ordinary gear selecting lever 32 is located outside the first gear shifting hole 21; moving from the direct gear to the overdrive gear: the direct gear and overdrive gear selecting lever 33 pushes, under the acting force of the gear shifting flexible shaft, the gearbox gear selecting and shifting shaft 1 to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm 2 to move so as to enable the direct gear and overdrive gear selecting lever 33 to be inserted into the second gear shifting hole 22, and the ordinary gear selecting lever 32 is located outside the first gear shifting hole 21; moving from the overdrive gear to the direct gear: the direct gear and overdrive gear selecting lever 33 pushes, under the acting force of the gear shifting flexible shaft, the gearbox gear selecting and shifting shaft 1 to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever 33 pushes, under the acting force of the gear shifting flexible shaft, the gearbox gear selecting and shifting shaft 1 to rotate forward to exit from the direct gear; Gear selecting: the gear selecting flexible shaft pushes the gear selecting and shifting rocker arm 2 to move to enable the ordinary gear selecting lever 32 to be inserted into the first gear shifting hole 21; at this time, the direct gear and overdrive gear selecting lever 33 exit to outside the second gear shifting hole 22; when the gear selecting and shifting block 4 is located between two gear shifting guide blocks, the interlocking base 5 is prohibited from shifting the gear; when the gear selecting and shifting block 4 is located in a single gear shifting guide block, entering into the top gear of the ordinary gear: the ordinary gear selecting lever 32 pushes under the acting force of the gear shifting flexible shaft, the gearbox gear selecting and shifting shaft 1 to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.

Principles of the present invention are described as follows:

The operating device for a gearbox of this design is universal:
for an overdrive gear gearbox, the overdrive gear gearbox is provided with an ordinary gear: a gear with a transmission ratio greater than 1; a direct gear: a gear with a transmission ratio equal to 1; a gearbox power output shaft and the power output shaft are in direct transmission; an overdrive gear: a gear with a transmission ratio less than 1. Because the direct gear in the gearbox is located on one end of the power output shaft close to power input shaft, and the direct gear, a direct gear and overdrive gear synchronizer, gears of the overdrive gear, and gears of the ordinary gear sequentially arranged from a high gear to a low gear are sequentially disposed on the power output shaft from the power input shaft side to the power output shaft side; and a corresponding synchronizer is disposed between gears of the ordinary gear. Because the direct gear is lower than the overdrive gear, to meet a gear arrangement rule when gear shifting is performed, direction conversion needs to be performed on the gear shifting force of the direct gear and the overdrive gear. Therefore, the gear shifting mechanism of this design meets different gear shifting direction requirements of the ordinary gear, the direct gear, and the overdrive gear by means of the ordinary gear selecting lever 32 and the direct gear and overdrive gear selecting lever 33 located on the upper end and the lower end of the gear selecting and shifting rocker arm 2.

for a direct gear gearbox, the overdrive gear gearbox is provided with an ordinary gear: a gear with a transmission ratio greater than 1; a direct gear: a gear with a transmission ratio equal to 1; a gearbox power input shaft and the power output shaft are in direct transmission; The transmission ratios of the gears on the power output shaft from the power input shaft side to the power output shaft side sequentially increase, directly meeting the arrangement rule of the gears of the gearbox. Therefore, a gear order reverse device is not required.

Because the direct gear gearbox does not require gear order reverse during a use process, this design can make the operating device for a gearbox to be applicable to the direct gear gearbox by changing the installation position of the gear shifting fork 3. In the direct gear gearbox, the gear selecting and shifting rocker arm 2 is only in transmission fit with the ordinary gear selecting lever 32, and the direct gear and overdrive gear selecting lever 33 does not contact with the gear selecting and shifting rocker arm 2. During a gear selecting process, the ordinary gear selecting lever 32 is always located inside a first gear shifting hole 21, thereby implementing gear shifting functions of the direct gear gearbox. Therefore, this design can be used for the direct gear gearbox and the overdrive gear gearbox of a same vehicle type. Such design is beneficial for standardizing the sizes of accessories, have small alterations for the entire vehicle, and can better meet requirements of the current assembling of the assembly line.

### Embodiment 1

Referring to FIG. 1 to FIG. 8, a universal operating device for an overdrive gearbox, including a gearbox gear selecting and shifting shaft 1, and a gear selecting and shifting rocker arm 2 and a gear selecting and shifting block 4 which are arranged on the gearbox gear selecting and shifting shaft; one end of the gearbox gear selecting and shifting shaft 1 is separately in transmission fit with a gear selecting flexible shaft and a gear shifting flexible shaft through the gear selecting and shifting rocker arm 2, and the other end of the gearbox gear selecting and shifting shaft 1 is in transmission fit with a gear shifting guide block through the gear selecting and shifting block 4; the gear selecting flexible shaft is in transmission fit with the gear selecting and shifting rocker arm 2 through an overdrive gear switching device 11; and the overdrive gear switching device 11 includes a gear shifting fork 3, the upper end of the gear shifting fork 3 is in transmission fit with the upper end of the gear selecting and shifting rocker arm 2, and the lower end of the gear shifting fork 3 is in transmission fit with the lower end of the gear selecting and shifting rocker arm 2. the gear shifting fork 3 includes a U-shaped fork lever 31, an ordinary gear selecting lever 32, a direct gear and overdrive gear selecting lever 33, and a transmission push lever 34; the ordinary gear selecting lever 32 and the direct gear and overdrive gear selecting lever 33 are disposed parallel to the gearbox gear selecting and shifting shaft 1; one end of the ordinary gear selecting lever 32 is in insertion fit with a first gear shifting hole 21 on the upper end of the gear selecting and shifting rocker arm 2; the other end of the ordinary gear selecting lever 32 is fixedly connected to the upper end of the U-shaped fork lever 31; one end of the direct gear and overdrive gear selecting lever 33 is in insertion fit with a second gear shifting hole 22 on the lower end of the gear selecting and shifting rocker arm 2; the other end of the direct gear and overdrive gear selecting lever 33 is fixedly connected to the lower end of the U-shaped fork lever 31; and a transmission push lever 34 is fixedly connected to the middle part of the U-shaped fork lever 31, and the transmission push lever 34 is in transmission fit with the gear shifting flexible shaft. a minimum distance between the end surface of the ordinary gear selecting lever 32 and the end surface of the direct gear and overdrive gear selecting lever 33 along an axial direction of the gearbox gear selecting and shifting shaft 1 is 1 mm to 3 mm, and the end surface of the ordinary gear selecting lever 32 and the end surface of the direct gear and overdrive gear selecting lever 33 are of arc surface structures. the interlocking base 5 includes a base 52 and an interlocking block 53, the cross section of the base 52 is of a reverse U-shaped structure, the middle part of the base 52 is provided with a block installation hole 51, the gear selecting and shifting block 4 is in fit with the block installation hole 51, interlocking block 53 is respectively disposed on the top of the base 52 and two sides of the block installation hole 51, and the interlocking block 53 and the top of the gear selecting and shifting block 4 are disposed in a gearbox gear selecting groove; and the width of an opening on the bottom of the base 52 is less than an outer diameter of the gearbox gear selecting and shifting shaft 1.

A use method of a universal operating device for an overdrive gearbox, the use method including the following steps:

Step 1: gear selecting and shifting of an ordinary gear: when performing a gear selecting and shifting operation of the ordinary gear, the gear selecting flexible shaft pushes the gear selecting and shifting rocker arm 2 to move so as to enable the ordinary gear selecting lever 32 to be inserted into the first gear shifting hole 21; the direct gear and overdrive gear selecting lever 33 is located outside the second gear shifting hole 22; when the gear selecting and shifting block 4 is located between two gear shifting guide blocks, the interlocking base 5 is prohibited from shifting the gear; when the gear selecting and shifting block 4 is located in a single gear shifting guide block, the gear shifting operation has four situations:
when upshifting to a next gear, the rotation direction of the gearbox gear selecting and shifting shaft 1 is set as the forward rotation direction of the gearbox gear selecting and shifting shaft 1;
a. moving forward by an odd gear in the ordinary gear: the ordinary gear selecting lever 32 pushes, under the acting force of the gear shifting flexible shaft, the gearbox gear selecting and shifting shaft 1 to rotate forward so as to enter into the odd gear of the ordinary gear, and upshift is completed;
b. moving backward by an odd gear in the ordinary gear: the ordinary gear selecting lever 32 pushes, under the acting force of the gear shifting flexible shaft, the gearbox gear selecting and shifting shaft 1 to rotate reversely so as to exit from the odd gear of the ordinary gear, and downshift is completed;
c. moving forward by an even gear in the ordinary gear: the ordinary gear selecting lever 32, pushes, under the acting force of the gear shifting flexible shaft, the gearbox gear selecting and shifting shaft 1 to rotate reversely to enter into the even gear of the ordinary gear, and upshift is completed;
d. moving backward by an even gear of the ordinary gear: the ordinary gear selecting lever 32, pushes, under the acting force of the gear shifting flexible shaft, the gearbox gear selecting and shifting shaft 1 to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever 32 pushes, under the acting force of the gear shifting flexible shaft, the gearbox gear selecting and shifting shaft 1 to rotate forward to exit from the top gear of the ordinary gear; Gear selecting: the gear selecting flexible shaft pushes the gear selecting and shifting rocker arm 2 to move to enable the direct gear and overdrive gear selecting lever 33 to be inserted into the second gear shifting hole 22; at this time, the ordinary gear selecting lever 32 exit to outside the first gear shifting hole 21; during a gear selecting process, when the gear selecting and shifting block 4 is located between two gear shifting guide blocks, the interlocking base 5 is prohibited from shifting the gear; when the gear selecting and shifting block 4 is located in a single gear shifting guide block, gear shifting can be performed; entering the direct gear: the direct gear and overdrive gear selecting lever 33 pushes, under an acting force of the gear shifting flexible shaft, the gearbox gear selecting and shifting shaft 1 to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm 2 to move so as to enable the direct gear and overdrive gear selecting lever 33 to be inserted into the second gear shifting hole 22, and the ordinary gear selecting lever 32 is located outside the first gear shifting hole 21; moving from the direct gear to the overdrive gear: the direct gear and overdrive gear selecting lever 33 pushes, under the acting force of the gear shifting flexible shaft, the gearbox gear selecting and shifting shaft 1 to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm 2 to move so as to enable the direct gear and overdrive gear selecting lever 33 to be inserted into the second gear shifting hole 22, and the ordinary gear selecting lever 32 is located outside the first gear shifting hole 21; moving from the overdrive gear to the direct gear: the direct gear and overdrive gear selecting lever 33 pushes, under the acting force of the gear shifting flexible shaft, the gearbox gear selecting and shifting shaft 1 to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever 33 pushes, under the acting force of the gear shifting flexible shaft, the gearbox gear selecting and shifting shaft 1 to rotate forward to exit from the direct gear; Gear selecting: the gear selecting flexible shaft pushes the gear selecting and shifting rocker arm 2 to move to enable the ordinary gear selecting lever 32 to be inserted into the first gear shifting hole 21; at this time, the direct gear and overdrive gear selecting lever 33 exit to outside the second gear shifting hole 22; when the gear selecting and shifting block 4 is located between two gear shifting guide blocks, the interlocking base 5 is prohibited from shifting the gear; when the gear selecting and shifting block 4 is located in a single gear shifting guide block, entering into the top gear of the ordinary gear: the ordinary gear selecting lever 32, pushes, under the acting force of the gear shifting flexible shaft, the gearbox gear selecting and shifting shaft 1 to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.

### Embodiment 2

Embodiment 2 is basically the same as embodiment 1, and the difference is that:

the overdrive gear switching device 11 further comprises the gear shifting booster 6, a power output end of the gear shifting booster 6 is fixedly connected to one end of the transmission push lever 34, the other end of the transmission push lever 34 is fixedly connected to the middle part of the U-shaped fork lever 31, the middle part of the transmission push lever 34 is in transmission fit with the gear shifting flexible shaft, and the gear shifting booster 6 is a pneumatic device.

### Embodiment 3

Embodiment 3 is basically the same as embodiment 1, and the difference is that:

The gearbox gear selecting and shifting shaft 1 has a circular tube structure, and the gear selecting and shifting rocker arm 2 and the gear selecting and shifting block 4 are welded on an outer wall of the gearbox gear selecting and shifting shaft 1; an interlocking base 5 is sleeved on the gearbox gear selecting and shifting shaft 1, and the gear selecting and shifting block 4 is in transmission fit with the gear shifting guide block after passing through the interlocking base 5.

### Embodiment 4

Embodiment 4 is basically the same as embodiment 3, and the difference is that:

a self-locking base 7 is fixedly connected to the gearbox gear selecting and shifting shaft 1, the cross section of the self-locking base 7 is W-shaped, the self-locking base 7 is in limiting fit with a locking valve 71, and the self-locking base 7 is welded on the outer wall of the gearbox gear selecting and shifting shaft 1.

### Embodiment 5

Embodiment 5 is basically the same as embodiment 1, and the difference is that:

the gear shifting fork 3 further includes a U-shaped transmission groove element 35, the bottom of the U-shaped transmission groove element 35 is fixedly connected to the middle part of the transmission push lever 34, the U-shaped transmission groove element 35 is disposed parallel to the gearbox gear selecting and shifting shaft 1, and the gear shifting flexible shaft are in transmission fit with the U-shaped fork lever 31 by sequentially passing through an L-shaped gear shifting transmission plate 8, the U-shaped transmission groove element 35, and the transmission push lever 34; one end of the L-shaped gear shifting transmission plate 8 is connected to the gear shifting flexible shaft, the other end of the L-shaped gear shifting transmission plate 8 is in transmission fit with the U-shaped transmission groove element 35 through a gear shifting block 81 on the bottom of the L-shaped gear shifting transmission plate 8, the middle part of the L-shaped gear shifting transmission plate 8 is provided with a gear shifting positioning pin hole 82, the gear shifting positioning pin hole 82 is provided with a gear shifting positioning pin 83 that is in rotation fit with the gear shifting positioning pin hole 82, and the bottom of the gear shifting positioning pin 83 is fixedly connected to a gearbox casing.

### Embodiment 6

Embodiment 6 is basically the same as embodiment 5, and the difference is that:

a gear selecting U-shaped groove 23 is disposed on the top of the gear selecting and shifting rocker arm 2, the gear selecting U-shaped groove 23 is disposed perpendicular to the gearbox gear selecting and shifting shaft 1, and the gear selecting flexible shaft is in transmission fit with the gearbox gear selecting and shifting shaft 1 by sequentially using an L-shaped gear selecting transmission plate 9, the gear selecting U-shaped groove 23, and the gear selecting and shifting rocker arm 2; one end of the L-shaped gear selecting transmission plate 9 is connected to the gear shifting flexible shaft, the other end of the L-shaped gear selecting transmission plate 9 is in transmission fit with the gear selecting U-shaped groove 23 through a gear selecting block 91 on the bottom of the L-shaped gear selecting transmission plate 9, the middle part of the gear selecting transmission plate 9 is provided with a gear selecting positioning pin hole 92, the gear selecting positioning pin hole 92 is provided with a gear selecting positioning pin 93 that is in rotation fit with the gear selecting positioning pin hole 92, and the bottom of the gear selecting positioning pin 93 is fixedly connected to the gearbox casing.

What is claimed is:

1. A universal operating device for an overdrive gearbox, comprising a gearbox gear selecting and shifting shaft (1), and a gear selecting and shifting rocker arm (2) and a gear selecting and shifting block (4) which are arranged on the gearbox gear selecting and shifting shaft, wherein one end of the gearbox gear selecting and shifting shaft (1) is separately in transmission fit with a gear selecting flexible shaft and a gear shifting flexible shaft through the gear selecting and shifting rocker arm (2), and the other end of the gearbox gear selecting and shifting shaft (1) is in transmission fit with a gear shifting guide block through the gear selecting and shifting block (4);
the gear selecting flexible shaft is in transmission fit with the gear selecting and shifting rocker arm (2) through an overdrive gear switching device (11); and the overdrive gear switching device (11) comprises a gear shifting fork (3), the upper end of the gear shifting fork (3) is in transmission fit with the upper end of the gear selecting and shifting rocker arm (2), and the lower end of the gear shifting fork (3) is in transmission fit with the lower end of the gear selecting and shifting rocker arm (2).

2. The universal operating device for an overdrive gearbox according to claim 1, wherein
the gearbox gear selecting and shifting shaft (1) has a circular tube structure, and the gear selecting and shifting rocker arm (2) and the gear selecting and shifting block (4) are welded on an outer wall of the gearbox gear selecting and shifting shaft (1); and an interlocking base (5) is sleeved on the gearbox gear selecting and shifting shaft (1), and the gear selecting and shifting block (4) is in transmission fit with the gear shifting guide block after passing through the interlocking base (5).

3. The universal operating device for an overdrive gearbox according to claim 1, wherein
a self-locking base (7) is fixedly connected to the gearbox gear selecting and shifting shaft (1), the cross section of the self-locking base (7) is W-shaped, the self-locking base (7) is in limiting fit with a locking valve (71), and the self-locking base (7) is welded on the outer wall of the gearbox gear selecting and shifting shaft (1).

4. The universal operating device for an overdrive gearbox according to claim 1, wherein
the gear shifting fork (3) comprises a U-shaped fork lever (31), an ordinary gear selecting lever (32), a direct gear and overdrive gear selecting lever (33), and a transmission push lever (34); the ordinary gear selecting lever (32) and the direct gear and overdrive gear selecting lever (33) are disposed parallel to the gearbox gear selecting and shifting shaft (1); one end of the ordinary gear selecting lever (32) is in insertion fit with a first gear shifting hole (21) on the upper end of the gear selecting and shifting rocker arm (2); the other end of the ordinary gear selecting lever (32) is fixedly connected to the upper end of the U-shaped fork lever (31); one end of the direct gear and overdrive gear selecting lever (33) is in insertion fit with a second gear shifting hole (22) on the lower end of the gear selecting and shifting rocker arm (2); the other end of the direct gear and overdrive gear selecting lever (33) is fixedly connected to the lower end of the U-shaped fork lever (31); and a transmission push lever (34) is fixedly connected to the middle part of the U-shaped fork lever (31), and the transmission push lever (34) is in transmission fit with the gear shifting flexible shaft.

5. The universal operating device for an overdrive gearbox according to claim 2, wherein
the gear shifting fork (3) comprises a U-shaped fork lever (31), an ordinary gear selecting lever (32), a direct gear and overdrive gear selecting lever (33), and a transmission push lever (34); the ordinary gear selecting lever (32) and the direct gear and overdrive gear selecting lever (33) are disposed parallel to the gearbox gear selecting and shifting shaft (1); one end of the ordinary gear selecting lever (32) is in insertion fit with a first gear shifting hole (21) on the upper end of the gear selecting and shifting rocker arm (2); the other end of the ordinary gear selecting lever (32) is fixedly connected to the upper end of the U-shaped fork lever (31); one end of the direct gear and overdrive gear selecting lever (33) is in insertion fit with a second gear shifting hole (22) on the lower end of the gear selecting and shifting rocker arm (2); the other end of the direct gear and overdrive gear selecting lever (33) is fixedly connected to the lower end of the U-shaped fork lever (31); and a transmission push lever (34) is fixedly connected to the middle part of the U-shaped fork lever (31), and the transmission push lever (34) is in transmission fit with the gear shifting flexible shaft.

6. The universal operating device for an overdrive gearbox according to claim 3, wherein
the gear shifting fork (3) comprises a U-shaped fork lever (31), an ordinary gear selecting lever (32), a direct gear and overdrive gear selecting lever (33), and a transmission push lever (34); the ordinary gear selecting lever (32) and the direct gear and overdrive gear selecting lever (33) are disposed parallel to the gearbox gear selecting and shifting shaft (1); one end of the ordinary gear selecting lever (32) is in insertion fit with a first gear shifting hole (21) on the upper end of the gear selecting and shifting rocker arm (2); the other end of the ordinary gear selecting lever (32) is fixedly connected to the upper end of the U-shaped fork lever (31); one end of the direct gear and overdrive gear selecting lever (33) is in insertion fit with a second gear shifting hole (22) on the lower end of the gear selecting and shifting rocker arm (2); the other end of the direct gear and overdrive gear selecting lever (33) is fixedly connected to the lower end of the U-shaped fork lever (31); and a transmission push lever (34) is fixedly connected to the middle part of the U-shaped fork lever (31), and the transmission push lever (34) is in transmission fit with the gear shifting flexible shaft.

7. The universal operating device for an overdrive gearbox according to claim 4, wherein
the overdrive gear switching device (11) further comprises the gear shifting booster (6), a power output end of the gear shifting booster (6) is fixedly connected to one end of the transmission push lever (34), the other end of the transmission push lever (34) is fixedly connected to the middle part of the U-shaped fork lever (31), the middle part of the transmission push lever (34) is in transmission fit with the gear shifting flexible shaft, and the gear shifting booster (6) is a pneumatic device.

8. The universal operating device for an overdrive gearbox according to claim 5, wherein
the overdrive gear switching device (11) further comprises the gear shifting booster (6), a power output end of the gear shifting booster (6) is fixedly connected to one end of the transmission push lever (34), the other end of the transmission push lever (34) is fixedly connected to the middle part of the U-shaped fork lever (31), the middle part of the transmission push lever (34) is in transmission fit with the gear shifting flexible shaft, and the gear shifting booster (6) is a pneumatic device.

9. The universal operating device for an overdrive gearbox according to claim 6, wherein
the overdrive gear switching device (11) further comprises the gear shifting booster (6), a power output end of the gear shifting booster (6) is fixedly connected to one end of the transmission push lever (34), the other end of the transmission push lever (34) is fixedly connected to the middle part of the U-shaped fork lever (31), the middle part of the transmission push lever (34) is in transmission fit with the gear shifting flexible shaft, and the gear shifting booster (6) is a pneumatic device.

10. The universal operating device for an overdrive gearbox according to claim 7, wherein
the gear shifting fork (3) further comprises a U-shaped transmission groove element (35), the bottom of the U-shaped transmission groove element (35) is fixedly connected to the middle part of the transmission push lever (34), the U-shaped transmission groove element (35) is disposed parallel to the gearbox gear selecting and shifting shaft (1), and the gear shifting flexible shaft are in transmission fit with the U-shaped fork lever (31) by sequentially passing through an L-shaped gear shifting transmission plate (8), the U-shaped transmission groove element (35), and the transmission push lever (34); one end of the L-shaped gear shifting transmission plate (8) is connected to the gear shifting flexible shaft, the other end of the L-shaped gear shifting transmission plate (8) is in transmission fit with the U-shaped transmission groove element (35) through a gear shifting block (81) on the bottom of the L-shaped gear shifting transmission plate (8), the middle part of the L-shaped gear shifting transmission plate (8) is provided with a gear shifting positioning pin hole (82), the gear shifting positioning pin hole (82) is provided with a gear shifting positioning pin (83) that is in rotation fit with the gear shifting positioning pin hole (82), and the bottom of the gear shifting positioning pin (83) is fixedly connected to a gearbox casing.

11. The universal operating device for an overdrive gearbox according to claim 8, wherein
the gear shifting fork (3) further comprises a U-shaped transmission groove element (35), the bottom of the U-shaped transmission groove element (35) is fixedly connected to the middle part of the transmission push lever (34), the U-shaped transmission groove element (35) is disposed parallel to the gearbox gear selecting and shifting shaft (1), and the gear shifting flexible shaft are in transmission fit with the U-shaped fork lever (31) by sequentially passing through an L-shaped gear shifting transmission plate (8), the U-shaped transmission groove element (35), and the transmission push lever (34); one end of the L-shaped gear shifting transmission plate (8) is connected to the gear shifting flexible shaft, the other end of the L-shaped gear shifting transmission plate (8) is in transmission fit with the U-shaped transmission groove element (35) through a gear shifting block (81) on the bottom of the L-shaped gear shifting transmission plate (8), the middle part of the L-shaped gear shifting transmission plate (8) is provided with a gear shifting positioning pin hole (82), the gear shifting positioning pin hole (82) is provided with a gear shifting positioning pin (83) that is in rotation fit with the gear shifting positioning pin hole (82), and the bottom of the gear shifting positioning pin (83) is fixedly connected to a gearbox casing.

12. The universal operating device for an overdrive gearbox according to claim 9, wherein
the gear shifting fork (3) further comprises a U-shaped transmission groove element (35), the bottom of the U-shaped transmission groove element (35) is fixedly connected to the middle part of the transmission push lever (34), the U-shaped transmission groove element (35) is disposed parallel to the gearbox gear selecting and shifting shaft (1), and the gear shifting flexible shaft are in transmission fit with the U-shaped fork lever (31) by sequentially passing through an L-shaped gear shifting transmission plate (8), the U-shaped transmission groove element (35), and the transmission push lever (34); one end of the L-shaped gear shifting transmission plate (8) is connected to the gear shifting flexible shaft, the other end of the L-shaped gear shifting transmission plate (8) is in transmission fit with the U-shaped transmission groove element (35) through a gear shifting block (81) on the bottom of the L-shaped gear shifting transmission plate (8), the middle part of the L-shaped gear shifting transmission plate (8) is provided with a gear shifting positioning pin hole (82), the gear shifting positioning pin hole (82) is provided with a gear shifting positioning pin (83) that is in rotation fit with the gear shifting positioning pin hole (82), and the bottom of the gear shifting positioning pin (83) is fixedly connected to a gearbox casing.

13. The universal operating device for an overdrive gearbox according to claim 4, wherein
a minimum distance between the end surface of the ordinary gear selecting lever (32) and the end surface of the direct gear and overdrive gear selecting lever (33) along an axial direction of the gearbox gear selecting and shifting shaft (1) is 1 mm to 3 mm, and the end surface of the ordinary gear selecting lever (32) and the end surface of the direct gear and overdrive gear selecting lever (33) are of arc surface structures.

14. The universal operating device for an overdrive gearbox according to claim 4, wherein
the interlocking base (5) comprises a base (52) and an interlocking block (53), the cross section of the base (52) is of a reverse U-shaped structure, the middle part of the base (52) is provided with a block installation hole (51), the gear selecting and shifting block (4) is in fit with the block installation hole (51), interlocking block (53) is respectively disposed on the top of the base (52) and two sides of the block installation hole (51), and the interlocking block (53) and the top of the gear selecting and shifting block (4) are disposed in a gearbox gear selecting groove; and the width of an opening on the bottom of the base (52) is less than an outer diameter of the gearbox gear selecting and shifting shaft (1).

15. The universal operating device for an overdrive gearbox according to claim 4, wherein
a gear selecting U-shaped groove (23) is disposed on the top of the gear selecting and shifting rocker arm (2), the gear selecting U-shaped groove (23) is disposed perpendicular to the gearbox gear selecting and shifting shaft (1), and the gear selecting flexible shaft is in transmission fit with the gearbox gear selecting and shifting shaft (1) by sequentially using an L-shaped gear selecting transmission plate (9), the gear selecting U-shaped groove (23), and the gear selecting and shifting rocker arm (2); one end of the L-shaped gear selecting transmission plate (9) is connected to the gear shifting flexible shaft, the other end of the L-shaped gear selecting transmission plate (9) is in transmission fit with the gear selecting U-shaped groove (23) through a gear selecting block (91) on the bottom of the L-shaped gear selecting transmission plate (9), the middle part of the gear selecting transmission plate (9) is provided with a gear selecting positioning pin hole (92), the gear selecting positioning pin hole (92) is provided with a gear selecting positioning pin (93) that is in rotation fit with the gear selecting positioning pin hole (92), and the bottom of the gear selecting positioning pin (93) is fixedly connected to the gearbox casing.

16. The universal operating device for an overdrive gearbox according to claim 5, wherein
a gear selecting U-shaped groove (23) is disposed on the top of the gear selecting and shifting rocker arm (2), the gear selecting U-shaped groove (23) is disposed perpendicular to the gearbox gear selecting and shifting shaft (1), and the gear selecting flexible shaft is in transmission fit with the gearbox gear selecting and shifting shaft (1) by sequentially using an L-shaped gear selecting transmission plate (9), the gear selecting U-shaped groove (23), and the gear selecting and shifting rocker arm (2); one end of the L-shaped gear selecting transmission plate (9) is connected to the gear shifting flexible shaft, the other end of the L-shaped gear selecting transmission plate (9) is in transmission fit with the gear selecting U-shaped groove (23) through a gear selecting block (91) on the bottom of the L-shaped gear selecting transmission plate (9), the middle part of the gear selecting transmission plate (9) is provided with a gear selecting positioning pin hole (92), the gear selecting positioning pin hole (92) is provided with a gear selecting positioning pin (93) that is in rotation fit with the gear selecting positioning pin hole (92), and the bottom of the gear selecting positioning pin (93) is fixedly connected to the gearbox casing.

17. The universal operating device for an overdrive gearbox according to claim 6, wherein
a gear selecting U-shaped groove (23) is disposed on the top of the gear selecting and shifting rocker arm (2), the gear selecting U-shaped groove (23) is disposed perpendicular to the gearbox gear selecting and shifting shaft (1), and the gear selecting flexible shaft is in transmission fit with the gearbox gear selecting and shifting shaft (1) by sequentially using an L-shaped gear selecting transmission plate (9), the gear selecting U-shaped groove (23), and the gear selecting and shifting rocker arm (2); one end of the L-shaped gear selecting transmission plate (9) is connected to the gear shifting flexible shaft, the other end of the L-shaped gear selecting transmission plate (9) is in transmission fit with the gear selecting U-shaped groove (23) through a gear selecting block (91) on the bottom of the L-shaped gear selecting transmission plate (9), the middle part of the gear selecting transmission plate (9) is provided with a gear selecting positioning pin hole (92), the gear selecting positioning pin hole (92) is provided with a gear selecting positioning pin (93) that is in rotation fit with the gear selecting positioning pin hole (92), and the bottom of the gear selecting positioning pin (93) is fixedly connected to the gearbox casing.

18. A use method of the universal operating device for an overdrive gearbox in claim 5, wherein:
the use method comprises the following steps:
Step 1: gear selecting and shifting of an ordinary gear: when performing a gear selecting and shifting operation of the ordinary gear, the gear selecting flexible shaft pushes the gear selecting and shifting rocker arm (2) to move so as to enable the ordinary gear selecting lever (32) to be inserted into the first gear shifting hole (21); the direct gear and overdrive gear selecting lever (33) is located outside the second gear shifting hole (22); when the gear selecting and shifting block (4) is located between two gear shifting guide blocks, the interlocking base (5) is prohibited from shifting the gear; when the gear selecting and shifting block (4) is located in a single gear shifting guide block, the gear shifting operation has four situations:
when upshifting to a next gear, the rotation direction of the gearbox gear selecting and shifting shaft (1) is set as the forward rotation direction of the gearbox gear selecting and shifting shaft (1);
a. moving forward by an odd gear in the ordinary gear: the ordinary gear selecting lever (32) pushes, under the acting force of the gear shifting flexible shaft, the gearbox gear selecting and shifting shaft (1) to rotate forward so as to enter into the odd gear of the ordinary gear, and gear forwarding is completed;
b. moving backward by an odd gear in the ordinary gear: the ordinary gear selecting lever (32) pushes, under the acting force of the gear shifting flexible shaft, the gearbox gear selecting and shifting shaft (1) to rotate reversely so as to exit from the odd gear of the ordinary gear, and downshift is completed;
c. moving forward by an even gear in the ordinary gear: the ordinary gear selecting lever (32), pushes, under the acting force of the gear shifting flexible shaft, the gearbox gear selecting and shifting shaft (1) to rotate reversely to enter into the even gear of the ordinary gear, and upshift is completed;
d. moving backward by an even gear of the ordinary gear: the ordinary gear selecting lever (32), pushes, under the acting force of the gear shifting flexible shaft, the gearbox gear selecting and shifting shaft (1) to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever (32) pushes, under the acting force of the gear shifting flexible shaft, the gearbox gear selecting and shifting shaft (1) to rotate forward to exit from the top gear of the ordinary gear; Gear selecting: the gear selecting flexible shaft pushes the gear selecting and shifting rocker arm (2) to move to enable the direct gear and overdrive gear selecting lever (33) to be inserted into the second gear shifting hole (22); at this time, the ordinary gear selecting lever (32) exit to outside the first gear shifting hole (21); during a gear selecting process, when the gear selecting and shifting block (4) is located between two gear shifting guide blocks, the interlocking base (5) is prohibited from shifting the gear; when the gear selecting and shifting block (4) is locate in a single gear shifting guide block, gear shifting can be performed; entering the direct gear: the direct gear and overdrive gear selecting lever (33) pushes, under an acting force of the gear shifting flexible shaft, the gearbox gear selecting and shifting shaft (1) to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the direct gear to the overdrive gear: the direct gear and overdrive gear selecting lever (33) pushes, under the acting force of the gear shifting flexible shaft, the gearbox gear selecting and shifting shaft (1) to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the overdrive gear to the direct gear: the direct gear and overdrive gear selecting lever (33) pushes, under the acting force of the gear shifting flexible shaft, the gearbox gear selecting and shifting shaft (1) to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever (33) pushes, under the acting force of the gear shifting flexible shaft, the gearbox gear selecting and shifting shaft (1) to rotate forward to exit from the direct gear; Gear selecting: the gear selecting flexible shaft pushes the gear selecting and shifting rocker arm (2) to move to enable the ordinary gear selecting lever (32) to be inserted into the first gear shifting hole (21); at this time, the direct gear and overdrive gear selecting lever (33) exit to outside the second gear shifting hole (22); when the gear selecting and shifting block (4) is located between two gear shifting guide blocks, the interlocking base (5) is prohibited from shifting the gear; when the gear selecting and shifting block (4) is locate in a single gear shifting guide block, entering into the top gear of the ordinary gear: the ordinary gear selecting lever (32) pushes under the acting force of the gear shifting flexible shaft, the gearbox gear selecting and shifting shaft (1) to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.

19. A use method of the universal operating device for an overdrive gearbox in claim 7, wherein:
the use method comprises the following steps:
Step 1: gear selecting and shifting of an ordinary gear: when performing a gear selecting and shifting operation of the ordinary gear, the gear selecting flexible shaft pushes the gear selecting and shifting rocker arm (2) to move so as to enable the ordinary gear selecting lever (32) to be inserted into the first gear shifting hole (21); the direct gear and overdrive gear selecting lever (33) is located outside the second gear shifting hole (22); when the gear selecting and shifting block (4) is located between two gear shifting guide blocks, the interlocking base (5) is prohibited from shifting the gear; when the gear selecting and shifting block (4) is located in a single gear shifting guide block, the gear shifting operation has four situations:
when upshifting to a next gear, the rotation direction of the gearbox gear selecting and shifting shaft (1) is set as the forward rotation direction of the gearbox gear selecting and shifting shaft (1);
a. moving forward by an odd gear in the ordinary gear: the ordinary gear selecting lever (32) pushes, under the acting force of the gear shifting flexible shaft, the gearbox gear selecting and shifting shaft (1) to rotate forward so as to enter into the odd gear of the ordinary gear, and gear forwarding is completed;
b. moving backward by an odd gear in the ordinary gear: the ordinary gear selecting lever (32) pushes, under the acting force of the gear shifting flexible shaft, the gearbox gear selecting and shifting shaft (1) to rotate reversely so as to exit from the odd gear of the ordinary gear, and downshift is completed;
c. moving forward by an even gear in the ordinary gear: the ordinary gear selecting lever (32), pushes, under the acting force of the gear shifting flexible shaft, the gearbox gear selecting and shifting shaft (1) to rotate reversely to enter into the even gear of the ordinary gear, and upshift is completed;
d. moving backward by an even gear of the ordinary gear: the ordinary gear selecting lever (32), pushes, under the acting force of the gear shifting flexible shaft, the gearbox gear selecting and shifting shaft (1) to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever (32) pushes, under the acting force of the gear shifting flexible shaft, the gearbox gear selecting and shifting shaft (1) to rotate forward to exit from the top gear of the ordinary gear; Gear selecting: the gear selecting flexible shaft pushes the gear selecting and shifting rocker arm (2) to move to enable the direct gear and overdrive gear selecting lever (33) to be inserted into the second gear shifting hole (22); at this time, the ordinary gear selecting lever (32) exit to outside the first gear shifting hole (21); during a gear selecting process, when the gear selecting and shifting block (4) is located between two gear shifting guide blocks, the interlocking base (5) is prohibited from shifting the gear; when the gear selecting and shifting block (4) is locate in a single gear shifting guide block, gear shifting can be performed; entering the direct gear: the direct gear and overdrive gear selecting lever (33) pushes, under an acting force of the gear shifting flexible shaft, the gearbox gear selecting and shifting shaft (1) to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the direct gear to the overdrive gear: the direct gear and overdrive gear selecting lever (33) pushes, under the acting force of the gear shifting flexible shaft, the gearbox gear selecting and shifting shaft (1) to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the overdrive gear to the direct gear: the direct gear and overdrive gear selecting lever (33) pushes, under the acting force of the gear shifting flexible shaft, the gearbox gear selecting and shifting shaft (1) to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever (33) pushes, under the acting force of the gear shifting flexible shaft, the gearbox gear selecting and shifting shaft (1) to rotate forward to exit from the direct gear; Gear selecting: the gear selecting flexible shaft pushes the gear selecting and shifting rocker arm (2) to move to enable the ordinary gear selecting lever (32) to be inserted into the first gear shifting hole (21); at this time, the direct gear and overdrive gear selecting lever (33) exit to outside the second gear shifting hole (22); when the gear selecting and shifting block (4) is located between two gear shifting guide blocks, the interlocking base (5) is prohibited from shifting the gear; when the gear selecting and shifting block (4) is locate in a single gear shifting guide block, entering into the top gear of the ordinary gear: the ordinary gear selecting lever (32) pushes under the acting force of the gear shifting flexible shaft, the gearbox gear selecting and shifting shaft (1) to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.

20. A use method of the universal operating device for an overdrive gearbox in claim 13, wherein:
the use method comprises the following steps:
Step 1: gear selecting and shifting of an ordinary gear: when performing a gear selecting and shifting operation of the ordinary gear, the gear selecting flexible shaft pushes the gear selecting and shifting rocker arm (2) to move so as to enable the ordinary gear selecting lever (32) to be inserted into the first gear shifting hole (21); the direct gear and overdrive gear selecting lever (33) is located outside the second gear shifting hole (22); when the gear selecting and shifting block (4) is located between two gear shifting guide blocks, the interlocking base (5) is prohibited from shifting the gear; when the gear selecting and shifting block (4) is located in a single gear shifting guide block, the gear shifting operation has four situations:
when upshifting to a next gear, the rotation direction of the gearbox gear selecting and shifting shaft (1) is set as the forward rotation direction of the gearbox gear selecting and shifting shaft (1);
a. moving forward by an odd gear in the ordinary gear: the ordinary gear selecting lever (32) pushes, under the acting force of the gear shifting flexible shaft, the gearbox gear selecting and shifting shaft (1) to rotate forward so as to enter into the odd gear of the ordinary gear, and gear forwarding is completed;
b. moving backward by an odd gear in the ordinary gear: the ordinary gear selecting lever (32) pushes, under the acting force of the gear shifting flexible shaft, the gearbox gear selecting and shifting shaft (1) to rotate reversely so as to exit from the odd gear of the ordinary gear, and downshift is completed;
c. moving forward by an even gear in the ordinary gear: the ordinary gear selecting lever (32), pushes, under the acting force of the gear shifting flexible shaft, the gearbox gear selecting and shifting shaft (1) to rotate reversely to enter into the even gear of the ordinary gear, and upshift is completed;
d. moving backward by an even gear of the ordinary gear: the ordinary gear selecting lever (32), pushes, under the acting force of the gear shifting flexible shaft, the gearbox gear selecting and shifting shaft (1) to rotate forward to exit from the even gear of the ordinary gear, and downshift is completed;
Step 2: moving the top gear of the ordinary gear to the direct gear: when the gearbox gear is located on the top gear of the ordinary gear, accelerating to enter into the direct gear, and exiting from the top gear of the ordinary gear; the ordinary gear selecting lever (32) pushes, under the acting force of the gear shifting flexible shaft, the gearbox gear selecting and shifting shaft (1) to rotate forward to exit from the top gear of the ordinary gear; Gear selecting: the gear selecting flexible shaft pushes the gear selecting and shifting rocker arm (2) to move to enable the direct gear and overdrive gear selecting lever (33) to be inserted into the second gear shifting hole (22); at this time, the ordinary gear selecting lever (32) exit to outside the first gear shifting hole (21); during a gear selecting process, when the gear selecting and shifting block (4) is located between two gear shifting guide blocks, the interlocking base (5) is prohibited from shifting the gear; when the gear selecting and shifting block (4) is locate in a single gear shifting guide block, gear shifting can be performed; entering the direct gear: the direct gear and overdrive gear selecting lever (33) pushes, under an acting force of the gear shifting flexible shaft, the gearbox gear selecting and shifting shaft (1) to rotate reversely to enter the direct gear, so that gear shifting is completed;
Step 3: moving from the direct gear to the overdrive gear: when the gearbox gear is located on the direct gear, accelerating to enter into the overdrive gear; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the direct gear to the overdrive gear: the direct gear and overdrive gear selecting lever (33) pushes, under the acting force of the gear shifting flexible shaft, the gearbox gear selecting and shifting shaft (1) to rotate forward to enter from the direct gear into the overdrive gear, and gear shifting is completed;
Step 4: moving from the overdrive gear to the direct gear, and exiting from the overdrive gear to enter into the direct gear when an automobile needs to decelerate; gear selecting: the gear selecting flexible shaft pushes the gear selecting and shifting rocker arm (2) to move so as to enable the direct gear and overdrive gear selecting lever (33) to be inserted into the second gear shifting hole (22), and the ordinary gear selecting lever (32) is located outside the first gear shifting hole (21); moving from the overdrive gear to the direct gear: the direct gear and overdrive gear selecting lever (33) pushes, under the acting force of the gear shifting flexible shaft, the gearbox gear selecting and shifting shaft (1) to rotate reversely to downshift from the overdrive gear to the direct gear, and gear shifting is completed;
Step 5: moving from the direct gear to the top gear of the ordinary gear, and exiting from the direct gear to enter into the top gear of the ordinary gear when the automobile needs to continue decelerating; exiting from the direct gear: the direct gear and overdrive gear selecting lever (33) pushes, under the acting force of the gear shifting flexible shaft, the gearbox gear selecting and shifting shaft (1) to rotate forward to exit from the direct gear; Gear selecting: the gear selecting flexible shaft pushes the gear selecting and shifting rocker arm (2) to move to enable the ordinary gear selecting lever (32) to be inserted into the first gear shifting hole (21); at this time, the direct gear and overdrive gear selecting lever (33) exit to outside the second gear shifting hole (22); when the gear selecting and shifting block (4) is located between two gear shifting guide blocks, the interlocking base (5) is prohibited from shifting the gear; when the gear selecting and shifting block (4) is locate in a single gear shifting guide block, entering into the top gear of the ordinary gear: the ordinary gear selecting lever (32) pushes under the acting force of the gear shifting flexible shaft, the gearbox gear selecting and shifting shaft (1) to rotate reversely to enter into the top gear of the ordinary gear, and gear shifting is completed;
Step 6: downshifting gear by gear and parking: the automobile gradually decelerate, and the gearbox downshifts gear by gear in the ordinary gear, and then parking is performed.
